(19) United States
(12) Patent Application Publication
(10) Pub. No.: US 2007/0295060 A1
(43) Pub. Date: Dec. 27, 2007

(54) AMPOULE CARD LEAK DETECTOR ASSEMBLY

(76) Inventors: Juan C. Delgado, Woodland, TX (US); Lorens Slokovic, Cleburne, TX (US)

Correspondence Address: Joel B. German - T2-7H;Allergan, Inc., 2525 Dupont Drive, Irvine, CA, 92612-1531, US

(21) Appl. No.: 11/760,055

(22) Filed: Jun. 8, 2007

Related U.S. Application Data
(60) Provisional application No. 60/813,291, filed on Jun. 13, 2006.

(51) Int. Cl. G01M 3/34

(52) U.S. Cl. 73/49.3

(57) ABSTRACT

Systems and methods are provided for inspecting ampoule packages for the presence of leaks. The systems and methods may be part of a manufacturing line for ampoule packages, particularly flexible ampoule cards that contain sterile pharmaceutical solutions. The solution-containing packages are compressed in an amount sufficient to cause leaking of solution from a pre-existing tear or perforation in an ampoule. The amount of compression applied is less than that required to cause significant package damage such as bursting. The packages are compressed using surfaces of sensing grids which are effective in detecting presence of a liquid outside the package during the compression. By using the conductive properties of the solution, sensing grids and appropriate circuitry can be used to signal or cause an alarm in the event a package has been determined to contain a leak.

### CROSS REFERENCE TO RELATED APPLICATIONS

This application is based on, and claims the benefit of, U.S. Provisional Application No. 60/813,291, filed Jun. 13, 2006, and which is incorporated herein by reference.

### BACKGROUND

The present invention generally relates to manufacture of pharmaceutical products and more specifically relates to systems and methods of inspecting newly manufactured ampoule cards.

Ampoule cards are used as containers for aseptic or sterile compositions in the pharmaceutical industries, particularly for the sterile packaging of injectable solutions.

It would be advantageous in a manufacturing facility to provide a system for reliably detecting defective ampoule packages, for example, ampoule packages which include a leak, rupture, hole, perforation, tear or other breach in an ampoule of the package. The defective cards could then be rejected and prevented from reaching a consumer. The present invention meets these and other needs and objectives.

### SUMMARY OF THE INVENTION

Accordingly, the present invention provides systems and methods for inspecting ampoule packages, for example, ampoule packages newly-filled with pharmaceutical solutions, for the presence of a structural breach, typically a leak, in the package. By breach is generally meant herein to include any leak, rupture, hole, perforation, tear or other breach in a wall of an ampoule which compromises integrity of the package contents. A breach or leak in the sense intended herein may or may not allow any visually observable escaping of fluid to an outside surface of the ampoule.

The present systems and methods are especially useful as a component of a larger manufacturing system for ampoule packages, for example, ampoule cards.

An ampoule package, as the term is used herein, typically refers to a package for containing fluid compositions, for example, water-based or alcohol-based pharmaceutical solutions, and the like. An ampoule package may be in the form of an ampoule card, generally made of a backing material and one or more individual flexible plastic solution-filled ampoules supported by the backing material. Each ampoule usually contains a pre-measured dosage of solution. The solution may be in the form of a liquid, gel, suspension or other flowable material. The backing material comprises, for example, a laminated cardstock material. In ampoule cards, the ampoules are spaced apart along a face of the backing material and secured thereto by plastic laminate. Commonly, the solution contained in the ampoules may be extracted for medical, pharmaceutical, or cosmetic use by breaking the ampoule or insertion of a tip of a syringe, or any other suitable means.

Systems for inspecting ampoule packages are provided. In a broad aspect of the invention, the systems comprise a compression assembly capable of compressing an ampoule package, and a detector capable of detecting a breach in an ampoule by using a known electrical property of the solution to determine if a breach in the ampoule is present.

In accordance with more specific aspects of the invention, the system may further comprise an infeed system for conveying ampoule packages to a testing station which includes the compression assembly and detector. Various components of the system may be automated by use of a controller and programmed logic routines. In some embodiments, the infeed system includes an indexing system capable of effecting orderly movement of the packages through the system.

Advantageously, the compression assembly is structured to compress an ampoule package with just enough force sufficient to cause solution in the ampoule to leak from the ampoule to an exterior surface. The amount of compression is an amount that is insufficient to cause formation of a structural breach in a substantially identical package that does not include a preexisting structural breach. In other words, the compression will cause the ampoule to leak from a hole, perforation, tear, significant weak spot or the like that existed on the package prior to compression, but the compression is not enough to cause formation of a new hole, perforation, tear, significant weak spot or the like in a package that was relatively non-defective prior to compression.

The compression assembly compresses the package between two opposing compression surfaces. Detection of electrically conductive solution, for example, a water-based or an alcohol-based solution, on one of the compression surfaces indicates that one or more of the ampoules is/are leaking. All “leaking” ampoules are identified and removed and secured for human inspection and are prevented from reaching the consumer.

The compression assembly may include a static surface and an opposing dynamic, or moving, surface between which surfaces the ampoule package is compressed, for example, from an original width of less than about ½″, for example about ⅓″ to a compressed width of up to about ⅛″.

Preferably, the compression assembly is configured to electronically detect the presence of liquids on the compression surfaces. For example, at least one of the compression surfaces, for example, at least one of the static surface and the dynamic surface, is a conductive surface. The compression assembly may comprise for example, a first conductive surface and a second conductive surface each having appropriate circuitry connected thereto for enabling the system to sense solution is on the surface based on the electrical conductivity of the solution. For example, the conductive surface is connected to an electronic amplifier capable of conveying a signal to a control assembly in the event an increase in conductivity is sensed. In a more specific example, the compression assembly includes opposing sensing grids between which the package is compressed during testing.

The sensing surfaces are designed to facilitate cleaning thereof which becomes necessary in the event that a defective or leaking package has been detected. For example, the system may be equipped with blowers and/or the surfaces may be movable to a cleaning position to facilitate access thereto for manual cleaning.

The present system may be incorporated into a larger system for inspecting ampoules of ampoule packages. For example, the present systems may be incorporated into a manufacturing line for producing ampoule cards. The manufacturing line may include an ampoule fill station, and a package deflashing station and the present leak detection system. Preferably, the present system is incorporated into an ampoule package manufacturing system directly downstream of the deflashing station. It has been found that recently deflashed ampoule packages (“warm packages”) tend to be somewhat soft and flexible and work very well with the present inspection systems.

Methods for inspecting solution-containing ampoule packages are also provided by the present invention. The methods generally comprise the steps of compressing at least a portion of an ampoule package with a predetermined force, and using a known electrical property of the solution to determine if a breach in the ampoule is present. By sensing for electrical conductivity of the solution on one or more surfaces outside of the ampoule, a determination can be made whether solution from within the ampoule has leaked out of the ampoule while the package was under compression.

Any and all features described herein and combinations of such features are included within the scope of the present invention provided that the features of any such combination are not mutually inconsistent.

These and other aspects of the present invention are set forth in the following detailed description and claims, particularly when considered in conjunction with the accompanying drawings in which like parts bear like reference numerals.

### BRIEF DESCRIPTION OF THE DRAWINGS

FIGS. 1A and 1B show, in simplified form, a top view and side view, respectively, of a system of the invention.

FIG. 2 is a flow chart detailing a sequence of events in a method of the invention, the sequence of events being consistent with a typical operation of the system shown in FIGS. 1A and 1B.

FIG. 3 shows, in simplified form, a plan view of another system of the invention.

FIG. 4 is a flow chart detailing a sequence of events consistent with a typical operation of the system shown in FIG. 3.

### DETAILED DESCRIPTION

The present invention generally provides methods and systems for inspecting ampoule packages. The system is designed to ensure that each package that passes through the system has been inspected for presence of perforations, holes, breaks, cracks, ruptures or other significant structural breach in one or more ampoules of the package. The present systems and methods are especially useful as a component of a larger manufacturing system for producing such packages, for example, a manufacturing line for producing sterile, solution-containing, unit dose ampoule cards.

In a broad aspect of the invention, the present systems and methods are designed to provide a means for inspecting ampoule packages, for example, ampoule cards, and preventing any defective ampoule cards from passing through the system. The systems and methods generally utilize the electrical properties of the solution contained in the ampoule or ampoules of a package to detect for a breach that would render the package defective. It goes without saying that such a breach in an ampoule package could compromise sterility and/or integrity of the solutions contained therein. Further, it is well understood in the pharmaceutical product manufacturing industry that safety regulations require rigorous inspection of pharmaceutical packages prior to distribution thereof to the public. It is believed by the inventors hereof that the present inspection systems may be significantly more accurate in detecting structural breaches in certain packages than the leak detection systems and methods which are currently favored and/or approved for use in the pharmaceutical product packaging industry.

The packages inspected by the present systems and methods are generally what are called ampoule packages, which includes ampoule cards, individually packaged fluid-filled vials and the like. Generally, the ampoules in the packages inspected using the present systems typically contain fluid solutions, for example, sterile pharmaceutical solutions, for example, in the form of a liquid, gel, suspension, or other fluid form.

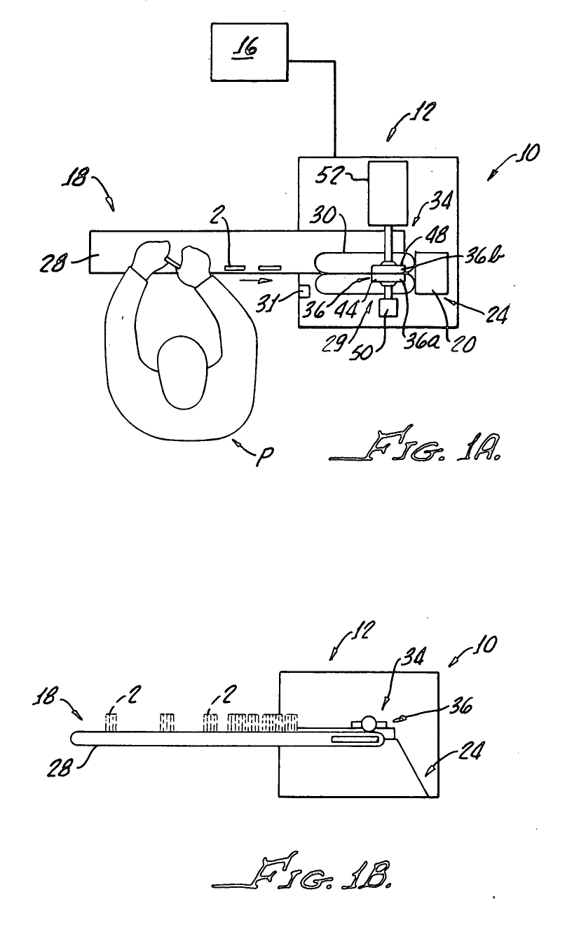

Turning now to FIGS. 1A and 1B, a system for inspecting packages 2 which include one or more solution-containing ampoules is generally shown at 10. The system 10 generally comprises a testing station 12, a controller 16, an infeed station 18 for conveying ampoule packages to the testing station 12, and an optional rejection and rejection verification mechanism 20 for facilitating removal of packages that have been determined to be defective.

The infeed system 18 is designed to deliver packages 2 to the testing station 12 in an automated, orderly manner. The infeed system 18 may include a common DC motor driven, low friction infeed belt 28 which runs at a constant speed. The infeed belt 28 extends along substantially the entire length of the system 10. Depending upon the size and/or shape of the packages being inspected, the infeed belt 28 may be about 1 inch to about 2 inches, to about 6 inches or more in width. In the shown embodiment, the packages 2 are being loaded onto the belt 28 in substantially vertically oriented, upright position, for example with tabs or caps of the ampoules directed downward toward the belt 28. As shown in FIG. 1A, packages 2 are being placed on the infeed belt 28 by an operator P and are conveyed toward the testing station 12.

The infeed system 18 preferably further includes and indexing mechanism 29 effective to feeding the packages in a controlled manner through the testing station 12. For example, an indexing mechanism 29 using a compounded index motion may be provided. In the shown embodiment, the indexing mechanism 29 includes two side belts 30 which move in accordance with a logic program.

For example, the side belts 30 are generally not moving at a constant rate of speed like infeed belt 28, but move in accordance with a cycle or sequence. For example, the side belts 30, both driven by a servo motor, move in accordance with a cycle or sequence as follows. Once a package 2 arrives at the testing station 12, the cycle or sequence is triggered to begin by means of a sensor 31, for example, a photo electric sensor. The package 2 becomes engaged between the side belts 30 and is moved thereby at a relatively slow speed for a time sufficient to ensure the package 2 is effectively engaged or secured between the belts 30. The side belts 30 may engage the package by gripping the downward pointing tabs of the ampoules. This initial indexed motion is “compounded” into a second indexed motion, the second indexed motion being a relatively high speed motion that rapidly moves the package 2 into the actual inspection area beyond the sensor 31. The second part of the compounded index occurs so rapidly that the action is completed before the package that follows arrives at the input end of the side belts 30. For example, the side belts 30 may be programmed to stop moving by the time the immediate next package 2 reaches sensor 31. The logic may include a time delay to reduce false triggers of the sensor 31. Upon completion of the time delay, the servo driven side belts 30 are started. It is noted that during the cycling of the side belts 30, the other packages moving toward the testing station 12, other than the package that is being indexed slowly and then at high speed, continue to move toward the side belts 30 at the constant speed of the infeed belt 28.

The infeed system 18 is designed to reduce the likelihood of jams and wedging of the packages 2 as they are moved along the infeed belt 28 and through testing station 12. For example, carefully planed rails and other support surfaces are provided to maintain a smooth path of travel. Appropriate railing is provided to ensure that packages 2 that run into each other at an output end of the infeed belt 28 will not wedge into each other. It is also noted that “warm” packages, for example, those which have just been deflashed, tend to move more smoothly through the system 10 than more rigid “cold” packages.

The motor drive for the infeed belt 28 may be a DC motor drive having the capability of an enable signal for communicating with the controller 16. For example, the motor drive may be connected to the controller 16 which provides user interface capabilities. An access card or other security device may provide means to control starting and speed of the infeed belt and limit access of the controller 16 to authorized personnel. The controller 16 may include, among other functions or controls, separate controls or buttons enabling emergency stop, start, stop and reset. An electronic operator panel may be provided for displaying counters and alarms, and inputs for entering settings such as timers, positions and speeds and to aid in trouble shooting.

Generally, when the side belts index cycle is completed, a linear actuator index cycle begins which activates compression of the package by means of a compression assembly 34. At the compression assembly 34, the package is compressed between two surfaces to a degree sufficient to cause leaking from a breach that is already present in the package. In other words, the compression assembly 34 is structured and operable to compress the package 2, for example, from an original width or thickness down to a smaller width or thickness, to cause solution to leak from a preexisting breach, which may be for example, a tear or hole in an ampoule. The package 2 is not compressed to a degree that would to cause a non-defective package to break or burst.

Advantageously, the testing station 12 further includes a detector 36. The detector 36 is preferably a highly sensitive liquid sensor detector that is capable of detecting even a very small amount of solution that has leaked from an ampoule during compression by the compression assembly 34. Advantageously, the detector 36 uses an electrical property of the solution to determine the presence of the solution outside of the ampoule.

For example, the compression assembly 34 includes first and second compression plates, 36a and 36b respectively, between which the package 2 is compressed. Each of the plates 36a, 36b may include an electrically conductive surface connected to an electronic amplifier and having appropriate circuitry to provide an output signal to the controller 16 when solution is sensed on the surface.

In a preferred embodiment of the invention, the first and second compression plates 36a and 36b each include an electronic sensing grid. The system 10 is designed such that a detection of solution on either of the compression surfaces will cause an alarm or signal to be sent to the controller 16 thereby informing an operator that a leak has been detected. The signal can be a voice or other audible signal, a visual signal or the like, or a combination thereof. Further, the controller 16 may be programmed to cause the cycling of the infeed belts, side belts and compression plates to automatically stop when a leak was detected. The infeed belt is stopped and the package is then manually or automatically removed from the system for visual inspection, tabulation, and/or disposal.

In the exemplary embodiment, the first compression plate 36a may comprise a static sensing grid 44 and the second compression plate 36b may comprise a dynamic sensing grid 48. The static sensing grid 44 is designed to remain substantially stationary during the compression and provides a surface against which the package is compressed by the moving dynamic sensing grid 48. Dynamic sensing grid 48 may be caused to dwell for a moment while in the compressed position, and then moves back to an open position. The sensing grids 44 and 48 are each connected to electronic circuits driven by resistance between the leads. When solution is present on either one of the sensing grids, an alarm is triggered, and/or a signal is sent to the controller 16. When a leak is detected, the system 10 automatically stops cycling. The system cannot be reset until the defective package is removed.

The system 10 may be configured such that a signal sent to the controller 16 is grid specific, in that the operator is informed which grid (e.g. static sensing grid 44 or dynamic sensing grid 48) has been contacted with leaking solution. When the system 10 stops, the grids 44, 48 are moved to a position that allows enough space for cleaning the grid surfaces.

The static sensing grid 44 is held in place by an air-driven cylinder 50. The static sensing grid 44 is preferably slightly spaced apart from, for example, is located at about ⅛″ (one-eighth of an inch) outside of, the path of the package 2. This arrangement is preferred in order to reduce possibility of friction damage to the static sensing grid 44.

The dynamic sensing grid 48 is driven by a servo linear actuator 52 which drives the dynamic sensing grid 48 toward and away from the static sensing grid 44 in accordance with a programmed cycle or sequence that works in cooperation with the indexing motion of the side belts 30. The amount of compression applied to the package is adjustable by adjusting the range or reach of the dynamic sensing grid 48. The dynamic sensing grid 48 is configured to be movable between three different positions, namely, a testing position, an open position, and a cleaning position.

Persons of skill in the art will appreciate that system 10 is not logically “fail safe” in that it is designed to inspect for a property of a package that is not supposed to be present (e.g. a leak in an ampoule). If the system is to be manually fed by an operator, this concern may be addressed by taking reasonable measures to ensure the system is operating properly in detecting defective packages. For example, the system 10 may be programmed to automatically queue the operator to run a “test dummy” through the system on a periodic basis for as long as the batch being run remains active. For example, the “test dummy” may comprise an ampoule package that includes a perforation in an ampoule wall. The system 10 will alert the operator when it is time to run the “test dummy” for example, at a frequency of once every hour. As a further precaution, the system 10 may be programmed such that after signaling for running the test, the system will automatically stop within five minutes of the signal if the test dummy has not been detected. An alarm is then displayed indicating to the operator that the operation can not be continued until the “test dummy” has been sensed and rejected.

Other precautions that can be taken to ensure effectiveness and accuracy of leak detection can be taken and will be known to those of skill in the art. For example, turning again specifically to FIG. 1A, the operator P feeding the packages onto the infeed belt 28 is preferably using gloves to handle the packages in order to avoid contamination of the package surfaces. Any type of humidity accumulated on the package surface may contribute to excessive false rejects and unnecessary downtime of the system 10. Likewise, contamination of gloves may require a change of gloves. Contamination of gloves can be caused by handling of alcohol, water, cleaning products, ophthalmic solutions and the like. Contact with any of these liquids may necessitate a change of gloves.

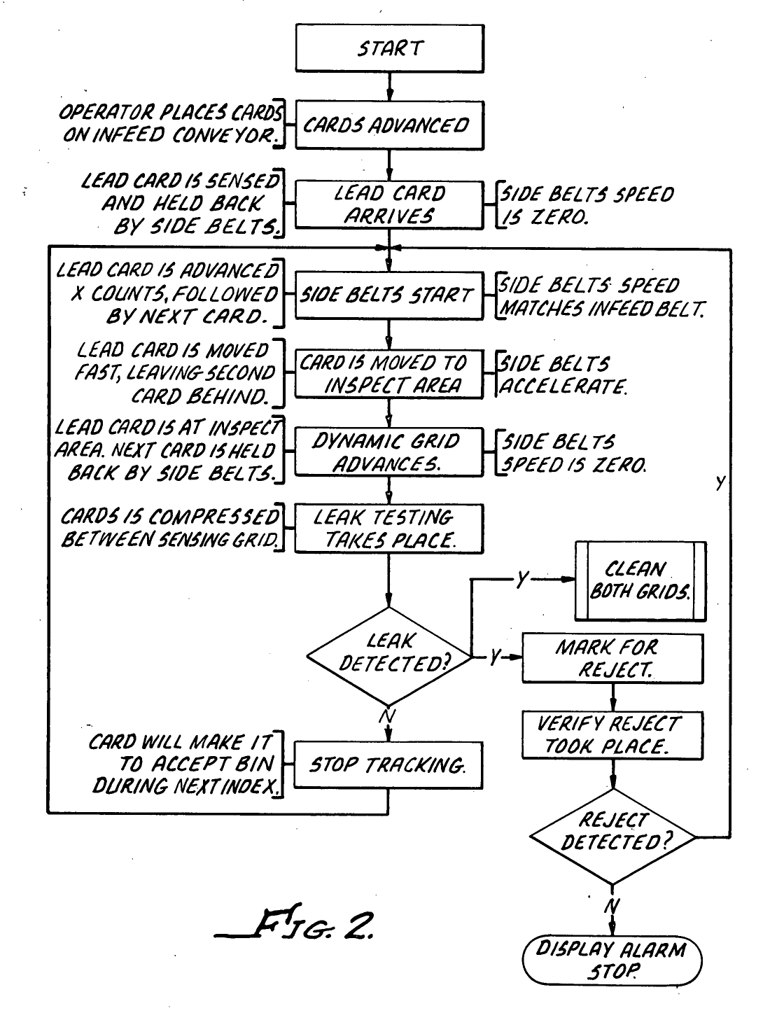

FIG. 2 is a flow chart that may be helpful in understanding certain aspects of the present invention. For the sake of simplicity, cleaning of the conductive surfaces is not shown in the flow chart of FIG. 2. Generally, cleaning simply involves the retraction of the dynamic sensing grid to the cleaning position. When the sensor grids have sensed a leak, the cycling of the system is automatically stopped and the grids are automatically moved to their respective cleaning positions. Air blowers may be triggered to blow dry the sensing surfaces. Alternatively, an operator may perform a manual cleaning routine. For example, the operator may wipe all sensing surfaces with a clean, lint-free cloth and non-conductive, non-abrasive cleaner, or other suitable means.

After the defective package has been removed from the testing station, the operator can then inspect the package in order to ascertain the location and/or nature of the leak. If it is discovered that a notably high number of package rejections have occurred and/or that leaks have been repeatedly discovered to be in the same location on several different packages, this information may be logged and used for facilitating trouble shooting upstream in the manufacturing line.

### EXAMPLE 1

A test is conducted to determine an appropriate amount of compression to be applied to ampoule packages to cause the ampoules to leak from a preexisting structural breach in the ampoule, without causing damage (e.g. breaking or bursting) of a non-defective ampoule.

For purposes of this specific Example, Package 1, Package 2, Package 3 and Package 4 are different types of ampoule packages which contain liquid solutions. Package 1 and Package 2 are standardized vials each containing a different pharmaceutical solution. Package 3 and Package 4 are vials having “twist-off” style caps. Package 3 and Package 4 contain different pharmaceutical solutions.

These four Packages are to be tested by compressing several packages representing each Package from an original thickness of about ⅓″ to ⅜″ to a thickness of about ⅛″.

The force required to reach this level of compression without breaking the packages can be calculated. For each of Packages 1 to 4, ten ampoule packages having an initial thickness of about 0.340″ are placed between two metal plates and compressed from original thickness down to about 0.125″ (i.e. ⅛″) using a pneumatic cylinder and arbor press. A pneumatic cylinder is placed between the compression plates and a pressure gauge is used to plug the cylinder port such that compression on the cylinder results in a pressure reading. During the course of this testing, none of the ampoules break.

The pneumatic cylinder has a diameter of 63 mm and an area of 4.832 square inches. The initial reading of the pressure gauge while sustaining the weight of the cylinder housing is about 6 psi.

In order to find the value of force exerted to reach this level of pressure, the delta of the pressure (i.e. the difference between the static value and the final value during compression) was multiplied by the cylinder area. The result is the force being applied in terms of pounds.

Compression sampling of the four Packages (Package 1, Package 2, Package 3 and Package 4) yields the results shown in Tables 1-4.

Package 5 is also tested using this technique. Package 5 test packages contain “pop-top” style ampoules. The ampoules in Package 5 are found to repeatedly pop open during the test. The calculated force required to achieve the desired compression varied from 149 pounds to 274 pounds. This greater standard deviation to achieve desired compression (relative to Packages 1 to 4) and the fact that all the ampoules of Package 5 experience bursting, leads to the decision that this Package will not be tested for leaks using system 10. Table 5 shows data representative of the testing of Package 5.

TABLE 1
PACKAGE 1

| Test no. | Thickness | Delta T | PSI | Delta PSI | Pounds |
|---|---|---|---|---|---|
| 1 | 0.344 | 0.219 | 46 | 40 | 193 |
| 2 | 0.344 | 0.219 | 45 | 39 | 188 |
| 3 | 0.342 | 0.217 | 45 | 39 | 188 |
| 4 | 0.346 | 0.221 | 44 | 38 | 184 |
| 5 | 0.349 | 0.224 | 46 | 40 | 193 |
| 6 | 0.335 | 0.210 | 47 | 41 | 198 |
| 7 | 0.350 | 0.225 | 46 | 40 | 193 |
| 8 | 0.348 | 0.223 | 55 | 49 | 237 |
| 9 | 0.344 | 0.219 | 46 | 40 | 193 |
| 10 | 0.349 | 0.224 | 41 | 35 | 169 |
| AVE | 0.345 | 0.220 | 46 | 40 | 194 |
| MAX | 0.350 | 0.225 | 55 | 49 | 237 |
| MIN | 0.335 | 0.210 | 41 | 35 | 169 |
| ST. DEV. | 0.004 | 0.004 | 4 | 4 | 17 |

TABLE 2
PACKAGE 2

| Test no. | Thickness | Delta T | PSI | Delta PSI | Pounds |
|---|---|---|---|---|---|
| 1 | 0.348 | 0.223 | 53 | 47 | 227 |
| 2 | 0.341 | 0.216 | 43 | 37 | 179 |
| 3 | 0.330 | 0.205 | 55 | 49 | 237 |
| 4 | 0.332 | 0.207 | 53 | 47 | 227 |
| 5 | 0.340 | 0.215 | 58 | 52 | 251 |
| 6 | 0.340 | 0.215 | 48 | 42 | 203 |
| 7 | 0.333 | 0.208 | 50 | 44 | 213 |
| 8 | 0.337 | 0.212 | 54 | 48 | 232 |
| 9 | 0.330 | 0.205 | 57 | 51 | 246 |
| 10 | 0.332 | 0.207 | 54 | 48 | 232 |
| AVE | 0.336 | 0.211 | 53 | 47 | 225 |
| MAX | 0.348 | 0.223 | 58 | 52 | 251 |
| MIN | 0.330 | 0.205 | 43 | 37 | 179 |
| ST. DEV. | 0.006 | 0.006 | 4 | 4 | 22 |

TABLE 3
PACKAGE 3

| Test no. | Thickness | Delta T | PSI | Delta PSI | Pounds |
|---|---|---|---|---|---|
| 1 | 0.353 | 2.228 | 40 | 34 | 164 |
| 2 | 0.351 | 0.226 | 50 | 44 | 213 |
| 3 | 0.348 | 0.223 | 30 | 24 | 116 |
| 4 | 0.344 | 0.219 | 30 | 24 | 116 |
| 5 | 0.345 | 0.220 | 34 | 28 | 135 |
| 6 | 0.350 | 0.225 | 31 | 25 | 121 |
| 7 | 0.347 | 0.222 | 35 | 29 | 140 |
| 8 | 0.340 | 0.215 | 38 | 32 | 155 |
| 9 | 0.343 | 0.218 | 43 | 37 | 179 |
| 10 | 0.349 | 0.224 | 40 | 34 | 164 |
| AVE | 0.347 | 0.222 | 37 | 31 | 150 |
| MAX | 0.353 | 0.228 | 50 | 44 | 213 |
| MIN | 0.340 | 0.215 | 30 | 24 | 116 |
| ST. DEV. | 0.004 | 0.004 | 6 | 6 | 31 |

TABLE 4
PACKAGE 4

| Test no. | Thickness | Delta T | PSI | Delta PSI | Pounds |
|---|---|---|---|---|---|
| 1 | 0.340 | 0.215 | 40 | 34 | 164 |
| 2 | | | 40 | 34 | 164 |
| 3 | | | 44 | 38 | 184 |
| 4 | 0.334 | 0.209 | 45 | 39 | 188 |
| 5 | 0.337 | 0.212 | 44 | 38 | 184 |
| 6 | 0.330 | 0.205 | 41 | 35 | 169 |
| 7 | 0.338 | 0.213 | 53 | 47 | 227 |
| 8 | 0.343 | 0.218 | 55 | 49 | 237 |
| 9 | 0.342 | 0.217 | 51 | 45 | 217 |
| 10 | 0.341 | 0.216 | 51 | 45 | 217 |
| AVE | 0.338 | 0.213 | 46 | 40 | 195 |
| MAX | 0.343 | 0.218 | 55 | 49 | 237 |
| MIN | 0.330 | 0.205 | 40 | 34 | 164 |
| ST. DEV. | 0.004 | 0.004 | 6 | 6 | 27 |

TABLE 5
PACKAGE 5

| Test no. | Thickness | Delta T | PSI | Delta PSI | Pounds |
|---|---|---|---|---|---|
| 1 | 0.378 | 0.253 | 85 | 80 | 243 |
| 2 | 0.372 | 0.247 | 60 | 55 | 167 |
| 3 | 0.373 | 0.248 | 55 | 49 | 149 |
| 4 | 0.372 | 0.247 | 87 | 82 | 250 |
| 5 | 0.372 | 0.247 | 86 | 80 | 243 |
| 6 | 0.375 | 0.250 | 75 | 70 | 213 |
| 7 | 0.364 | 0.239 | 95 | 90 | 274 |
| AVE | 0.372 | 0.247 | 78 | 72 | 220 |
| MAX | 0.378 | 0.253 | 95 | 90 | 274 |
| MIN | 0.364 | 0.239 | 55 | 49 | 149 |
| ST. DEV. | 0.004 | 0.004 | 15 | 15 | 46 |

### EXAMPLE 2

### Using Electrical Properties of Solution for Leak Testing

This example is provided to describe a test that can be used to achieve proper calibration of the electrical components and circuitry for use in the present systems and methods. It is also provided to demonstrate the reliability of the present systems in being capable of detecting leaks using the electrical properties of certain solutions.

For purposes of this specific Example, Product 1, Product 2 and Product 3 are three different types of water-based pharmaceutical solutions that are packaged in ampoule packages for testing using the present systems and methods, for example, system 10.

As explained elsewhere herein, the present systems and methods use the electrical properties of the solution in the packages to detect the presence of the solution outside the compressed ampoule, for example, on a sensing grid.

The electronic amplifier connected to the sensing grids is constantly monitoring resistance at its input. Two available circuits, i.e. Circuit 1 and Circuit 2, are provided and a simple test is performed to determine the response of the two circuits.

A resistor decade box is connected at the inputs of the circuit tested. An audible response is heard when the resistance is lowered. The test yielded the following results:

| | |
|---|---|
| Circuit 1 | 11.60 Mega Ohms |
| Circuit 2 | 11.80 Mega Ohms |

For the present testing procedure, the characteristic that is preferred is that of the lowest resistance. Circuit 1 requires greater conductivity than Circuit 2. Therefore, Circuit 1 is the less desirable circuit of the two, as it requires the lowest resistance at its input before providing an output signal.

A method is devised to assess the resistivity of the three products (i.e. Product 1, Product 2 and Product 3). The procedure is as follows:

For each Product, a drop of the Product is dispensed from an ampoule that contains the Product onto a clean glass surface with marked lines every 1/10″. All reasonable attempts are made to have three (3) drops approaching a diameter of 1/10″ from each Product. Once the three drops have been placed on the glass surface, the ampoule containing the Product is removed from the area to avoid revisiting of the sampling dispensing and any visual bias.

A digital multimeter is used to determine the resistance of each drop. The probes of the multimeter are placed at approximately 1/10″ apart and in contact with the solution. After the probes are correctly positioned, one value is observed in the digital multimeter display. The value is recorded.

Tables 6-8 show the results of this test.

All values in Mega Ohms.

TABLE 6
PRODUCT 1

| Ampoule | Meas. #1 | Meas. #2 | Meas. #3 | Average |
|---|---|---|---|---|
| 1 | 1.30 | 1.10 | 1.30 | 1.23 |
| 2 | 1.20 | 1.30 | 1.70 | 1.40 |
| 3 | 0.79 | 0.82 | 0.87 | 0.83 |
| 4 | 1.18 | 1.25 | 1.60 | 1.34 |
| 5 | 1.40 | 1.18 | 1.15 | 1.24 |
| 6 | 1.02 | 1.45 | 1.55 | 1.34 |
| 7 | 1.75 | 2.07 | 1.89 | 1.90 |
| 8 | 1.21 | 1.04 | 1.45 | 1.23 |
| 9 | 1.97 | 2.20 | 2.27 | 2.15 |
| 10 | 2.50 | 3.30 | 3.12 | 2.97 |

TABLE 7
PRODUCT 2

| Ampoule | Meas. #1 | Meas. #2 | Meas. #3 | Average |
|---|---|---|---|---|
| 1 | 3.25 | 3.60 | 4.20 | 3.68 |
| 2 | 3.30 | 3.80 | 2.70 | 3.27 |
| 3 | 2.40 | 2.90 | 3.40 | 2.90 |
| 4 | 1.67 | 2.02 | 2.26 | 1.98 |
| 5 | 2.14 | 2.54 | 2.87 | 2.52 |
| 6 | 2.24 | 2349 | 2.08 | 2.27 |
| 7 | 2.57 | 2322 | 2.96 | 2.58 |
| 8 | 2.85 | 3.11 | 2.86 | 2.94 |
| 9 | 2.48 | 2.69 | 2.24 | 2.47 |
| 10 | 3.22 | 2.12 | 2.29 | 2.54 |

TABLE 8
PRODUCT 3

| Ampoule | Meas. #1 | Meas. #2 | Meas. #3 | Average |
|---|---|---|---|---|
| 1 | 3.07 | 2.80 | 4.70 | 3.52 |
| 2 | 3.50 | 4.60 | 4.20 | 4.10 |
| 3 | 5.80 | 6.70 | 5.90 | 6.13 |
| 4 | 5.70 | 4.20 | 7.50 | 5.80 |
| 5 | 4.60 | 5.90 | 5.70 | 5.40 |
| 6 | 4.90 | 6.40 | 7.07 | 6.12 |
| 7 | 3.78 | 5.52 | 5.92 | 5.07 |
| 8 | 7.05 | 7.80 | 6.78 | 7.21 |
| 9 | 4.02 | 5.70 | 6.22 | 5.31 |
| 10 | 5.30 | 5.20 | 5.39 | 5.30 |

The data indicates that Product 3 is the least conductive solution of the three Products tested, with a maximum value of 7.21 Mega Ohms. On the other hand, the most conductive solution is Product 1 with a maximum resistance value of 2.97 Mega Ohms.

The electrical characteristics of the Products as seen by a sensing grid surface is now assessed. The following method is used to observe and record resistance when the sensing grid is used instead of the digital multimeter probes.

The leads of the digital multimeter are connected to the two terminals of the sensing grid. A substantial amount of a first Product (e.g. Product 1) to be tested is dispensed on a glass surface. The dispensed solution is touched with a plastic stick in a random manner. The wetted tip of the plastic stick is placed in contact with the sensing grid such that some of the solution is delivered to the grid. The grid is left undisturbed until a reading in the multimeter display settles. Once the reading settles, it is recorded and the sensing grid is cleaned for use in testing the next one of the Products. The sampling as seen by the sensing grid yields the results in Tables 9-11.

TABLE 9
PRODUCT 1

| Meas. # | MegaOhms |
|---|---|
| 1 | 1.44 |
| 2 | 1.29 |
| 3 | 1.94 |
| 4 | 1.19 |
| 5 | 1.89 |
| 6 | 2.66 |
| 7 | 1.62 |
| 8 | 2.07 |
| 9 | 1.63 |
| 10 | 2.1 |
| Average | 1.78 |
| SD | 0.44 |
| Minimum | 1.19 |
| Maximum | 2.66 |

TABLE 10
PRODUCT 2

| Meas. # | MegaOhms |
|---|---|
| 1 | 2.28 |
| 2 | 3.71 |
| 3 | 4.37 |
| 4 | 2.98 |
| 5 | 3.55 |
| 6 | 0.84 |
| 7 | 0.96 |
| 8 | 1.62 |
| 9 | 2.41 |
| 10 | 2.51 |
| Average | 2.52 |
| SD | 1.17 |
| Minimum | 0.84 |
| Maximum | 4.37 |

TABLE 11
PRODUCT 3

| Meas. # | MegaOhms |
|---|---|
| 1 | 2.54 |
| 2 | 3.91 |
| 3 | 5.16 |
| 4 | 5.36 |
| 5 | 4.76 |
| 6 | 5.72 |
| 7 | 3.01 |
| 8 | 5.64 |
| 9 | 5.33 |
| 10 | 1.38 |
| Average | 4.28 |
| SD | 1.50 |
| Minimum | 1.38 |
| Maximum | 5.72 |

It can be seen from this data that the data obtained using the grid surface method in measuring resistance ranges closely correlate with the data obtained with the multimeter probe method. Again, the maximum resistance reading is that of Product 3 at 5.72 Mega Ohms. The Product shown to have the least resistance is that of Product 1, with a maximum resistance reading of 2.66 Mega Ohms.

From the results of these tests, it is determined that each of the Products in the trial is suitable for testing using the system 10. Each of Products 1, 2 and 3 has a resistance level that are well within the detection range of the electronic amplifier. In addition, by using the least sensitive circuit, i.e. Circuit 1 which triggers with 11.60 Mega Ohms, and using a base line of below 10.44 Mega Ohms to provide for a safety factor of −10%. This range is 3.23 Mega Ohms above the “worst condition,” 7.21 Mega Ohms as per the Average column of Table 8.

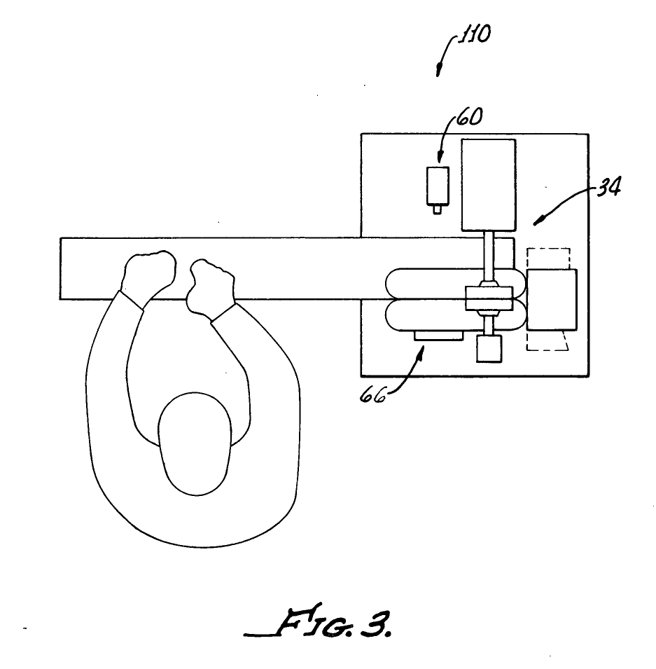

FIG. 3 shows another system in accordance with the invention generally at 110. System 110 is substantially the same as system 10 shown in FIGS. 1A and 1B, with the primary difference being that system 110 further includes the feature of a vision sensor 60 for facilitating empty ampoule detection. Vision sensor 60 is mounted in an appropriate location, for example, immediately upstream of the compression assembly 34 and is capable of using level of illumination of light through the package to detect whether the package contains an empty ampoule. The vision sensor 60 may be a fully integrated vision sensor such as a Cognex® In-Sight vision sensor used in combination with a stroboscopic back light 66.

Additional information that may be useful in understanding the use of a vision sensor for empty ampoule detection, as well as certain other aspects of the present invention, may be found in commonly owned U.S. patent application Ser. No. 11/361,921, filed on Feb. 23, 2006, the entire disclosure of which being incorporated herein by this reference.

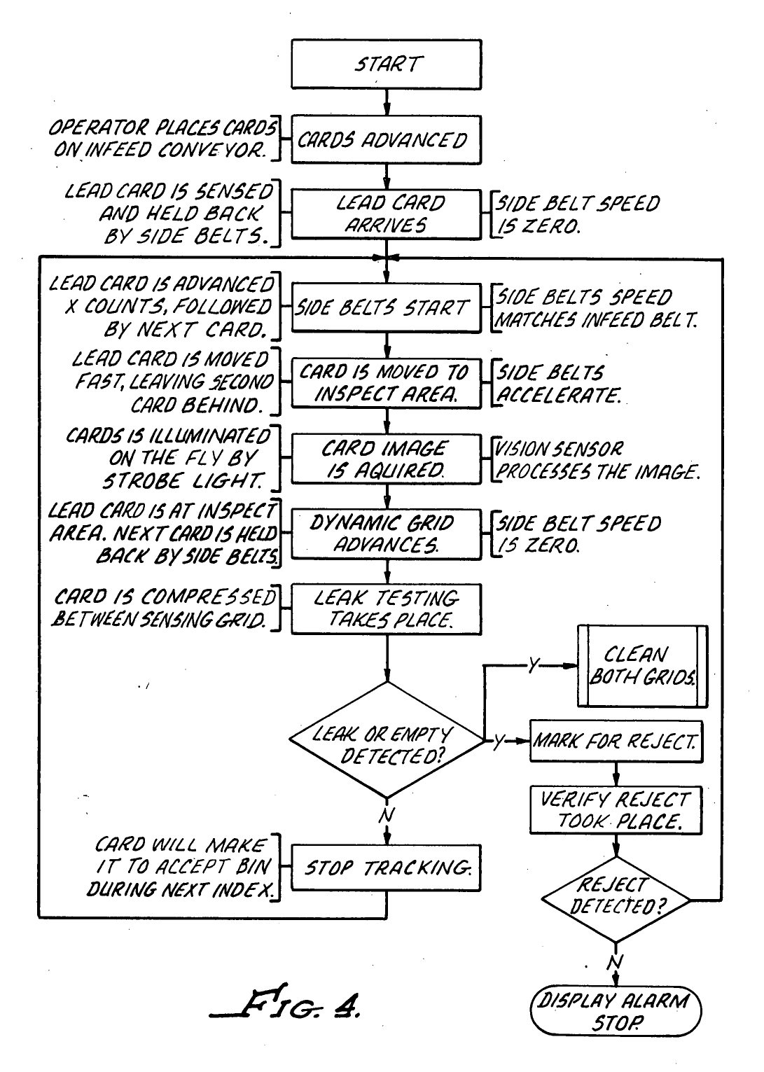

FIG. 4 is a flow chart showing a sequence of events consistent with a typical operation of system 110. As shown, the logic of system 110 is basically unchanged from system 10. Empty ampoule image processing using vision sensor 60 generally takes around 300 milliseconds. The vision sensor has ample time to process images acquired thereby and to send a pass signal to the controller while the leak detection of the package takes place. It is contemplated that reject-specific messages can be displayed on control panel (not shown in FIG. 3).

While this invention has been described with respect to various specific examples and embodiments, it is to be understood that the invention is not limited thereto and that it can be variously practiced within the scope of the following claims.

What is claimed is:

1. A method for inspecting ampoule packages, the method comprising:
detecting for the presence of a structural breach in a package that includes a solution-containing ampoule by
compressing at least a portion of a package an amount sufficient to cause leaking of solution from a preexisting structural breach in the package; and
sensing for a presence of leaked solution outside the ampoule by using an electrical property of the solution.

2. The method of claim 1 wherein the step of compressing includes compressing the package between two opposing surfaces, at least one of the surfaces being an electrically conductive surface.

3. The method of claim 1 wherein the amount sufficient to cause leaking is an amount that is insufficient to cause formation of a structural breach in a substantially identical package that does not include a preexisting structural breach.

4. The method of claim 1 wherein the step of compressing comprises compressing the package between two conductive surfaces.

5. The method of claim 1 wherein the step of compressing comprises compressing at least a portion of the package between a substantially static surface and a dynamic surface.

6. The method of claim 1 further comprising rejecting the package if the presence of leaked solution is sensed.

7. The method of claim 1 further comprising examining the package if leaked solution is sensed in order to determine at least one of a location and a nature of the breach.

8. The method of claim 1 wherein the package is a package comprising at least one pharmaceutical solution-containing ampoule.

9. The method of claim 1 wherein the step of compressing comprises compressing the package from an original width about ⅜″ to a width of up to about ⅛″.

10. The method of claim 1 wherein the step of sensing comprises using an electronic sensing grid.

11. A system for inspecting packages that include one or more solution-containing ampoules, the system comprising:
a compression assembly capable of compressing a package having at least one solution-containing ampoule; and
a detector capable of detecting a breach in an ampoule compressed by the compression assembly by using an electrical property of the solution to detect its presence on a surface exterior to the ampoule.

12. The system of claim 11 wherein the surface exterior to the ampoule is a conductive surface.

13. The system of claim 11 wherein the compression assembly includes a first electrically conductive surface and an opposing second electrically conductive surface.

14. The system of claim 11 wherein the surface exterior to the ampoule is used to compress the ampoule in the compression step.

15. The system of claim 11 wherein the detector comprises a sensing surface.

16. The system of claim 11 wherein the detector comprises a sensing surface and an electronic amplifier.

17. The system of claim 11 further comprising a conveyor effective to convey packages to the compression assembly.

18. The system of claim 17 further comprising an indexing mechanism for controlling passage of packages into the compression assembly.

19. A system for inspecting packages that include one or more solution-containing ampoules, the system comprising:
a testing station including
a compression assembly capable of compressing a package having at least one solution-containing ampoule, and
a detector capable of detecting a breach in an ampoule compressed by the compression assembly by using an electrical property of the solution to detect its presence on a surface exterior to the ampoule;
an infeed system configured to convey a package to the compression assembly; and
a controller system capable of controlling operation of at least one of the testing station and the infeed system.

20. The system of claim 19 wherein the detector comprises a compression surface including an electronic sensing grid.
